(19) United States
(12) Patent Application Publication
(10) Pub. No.: US 2013/0338882 A1
(43) Pub. Date: Dec. 19, 2013

(54) ACCESSORY SYSTEM FOR VEHICLE

(71) Applicant: MAGNA MIRRORS OF AMERICA, INC., Holland, MI (US)

(72) Inventor: Michael J. Baur, Holland, MI (US)

(73) Assignee: MAGNA MIRRORS OF AMERICA, INC., Holland, MI (US)

(21) Appl. No.: 13/902,038

(22) Filed: May 24, 2013

Related U.S. Application Data
(60) Provisional application No. 61/651,270, filed on May 24, 2012.

(51) Int. Cl. B60R 1/04

(52) U.S. Cl. CPC B60R 1/04
USPC 701/48; 701/36

(57) ABSTRACT

An accessory system for a vehicle includes an electronics module disposed at an interior surface of a windshield of the vehicle and a mirror head having an electro-optic reflective element. The mirror head is pivotally attached at the electronics module. Control circuitry is disposed in the electronics module. When the mirror head is pivotally attached at the electronics module, the control circuitry is electrically connected to the electro-optic reflective element of the mirror head. The control circuitry is at least operable to control the dimming of the electro-optic reflective element responsive to at least one photosensor. The control circuitry may be associated with at least one other function or system of the vehicle.

### CROSS REFERENCE TO RELATED APPLICATION

The present application claims the filing benefit of U.S. provisional application, Ser. No. 61/651,270, filed May 24, 2012, which is hereby incorporated herein by reference in its entirety.

### FIELD OF THE INVENTION

The present invention relates generally to the field of interior rearview mirror and accessory or front camera module systems for vehicles.

### BACKGROUND OF THE INVENTION

Typically, an interior rearview mirror assembly may include electrically powered accessories, such as cameras, photosensors, user inputs and/or display devices and/or the like, disposed at or in a mirror head of the mirror assembly. Such accessories add to the cost and weight of the mirror head, which is typically pivotally mounted at an interior portion of a vehicle, such as at an interior surface of the vehicle windshield.

### SUMMARY OF THE INVENTION

The present invention provides an interior rearview mirror and accessory or front camera module system that has reduced electrical content in the mirror head of the mirror assembly of the mirror and accessory module system, with the electrical accessories (such as a camera and/or photosensor and/or the like) disposed at a windshield electronics module (WEM) or front camera module (FCM) or the like, which is disposed at or near the mirror assembly and at or near the vehicle windshield. Electrical power may be provided to the mirror head (and any accessories therein, such as an electrochromic mirror reflective element and optionally a glare sensor), while the control circuitry and other accessories are located remote from the mirror head.

According to an aspect of the present invention, an interior rearview mirror and accessory or front camera module system includes an interior rearview mirror assembly for a vehicle comprising a mirror head and an electrically variable reflectance electro-optic mirror reflective element (such as, for example, and electrochromic mirror reflective element having front and rear glass substrates with an electrochromic medium sandwiched therebetween). Electro-optic auto-dimming control circuitry for the electro-optic mirror reflective element disposed in the mirror head is substantially located remote from the mirror head, and preferably at an accessory module or a windshield electronics module or a front camera module or the like, and electrical leads are provided from the control circuitry to the electro-optic mirror reflective element to control the dimming of the mirror reflective element responsive to the remotely located control circuitry and for any residual electrical items/accessories in the mirror head.

Also, the likes of exterior electro-optic mirror element drives (which provide electrical control signals/electrical power signals for a driver side electro-optic exterior mirror assembly and/or a passenger side electro-optic exterior mirror assembly) may be housed in the likes of a WEM or FCM rather than in the mirror head as is conventional today. Also, in accordance with the present invention, the likes of CAN or LIN bus controllers are located in the WEM/FCM rather than in the mirror head. Circuitry and circuit elements/components that today are conventionally housed in the mirror head are, preferably to the fullest extent practical, housed or disposed or located in the WEM/FCM rather than in the mirror head, and thereby can share and/or can have their function performed by circuitry and/or electronic elements/components that are already present in the WEM/FCM.

Optionally, the mirror head may include a glare sensor for sensing glare light at the mirror head, and the glare sensor may be electrically connected with the control circuitry. Optionally, a light pipe or the like may communicate the sensed light at the mirror head to a glare sensor and appropriate circuitry that is remotely located from the mirror head (such as at the electronics module). The control circuitry may be disposed at or near the windshield of the vehicle and may be disposed at or in an accessory module or electronics module or windshield electronics module or front camera module, where other circuitry and/or electronic accessories (such as a forward facing camera, an ambient light sensor, a display device, user inputs and/or the like) may be disposed.

Thus, the present invention provides an interior electro-optic mirror assembly with reduced or minimal electrical content, and with the electro-optic control circuitry disposed or located remote from the mirror head that supports the electro-optic mirror reflective element, with the electronic content typically housed in the mirror head now being housed in or disposed in an accessory or front camera module and/or sharing circuitry with circuitry or components of the accessory or front camera module. Thus, the mirror head and mirror assembly of the present invention provides a reduced cost and reduced weight mirror head and mirror assembly, and the mirror head may be supplied separately from the electronic accessories and electronic content often associated with mirror assemblies of vehicles.

These and other objects, advantages, purposes and features of the present invention will become apparent upon review of the following specification in conjunction with the drawings.

### BRIEF DESCRIPTION OF THE DRAWINGS

FIG. 1 is a side elevation of an interior rearview mirror and accessory or front camera module system in accordance with the present invention;

FIG. 2 is a perspective view of an electro-optic reflective element and glare sensor configuration of the interior rearview mirror and accessory module system of FIG. 1;

FIG. 3 is an electrical schematic of electrical communication between the mirror head and remotely located circuitry in accordance with the present invention; and

FIG. 4 is a block diagram showing various circuitry that may or may not be disposed in the mirror head of the interior rearview mirror and accessory module system of the present invention, with some of the circuitry or functions already present in an accessory module or the like.

### DESCRIPTION OF THE PREFERRED EMBODIMENTS

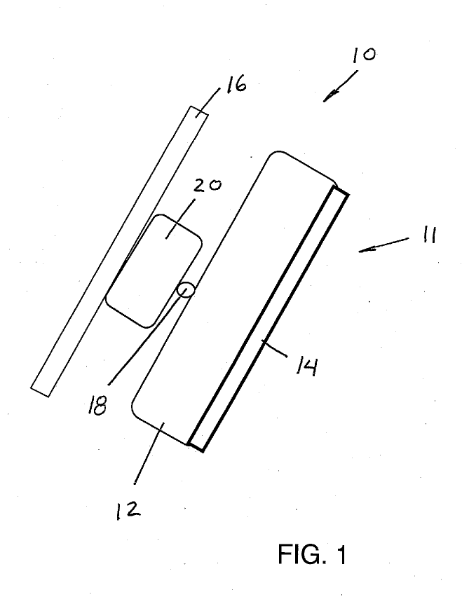

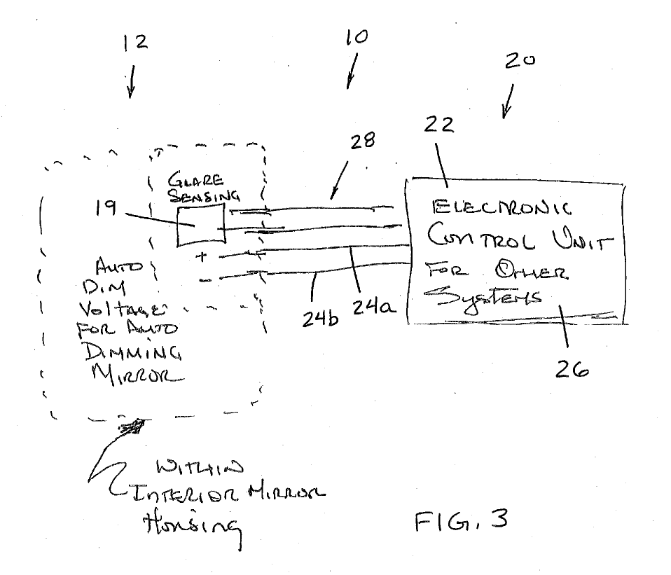

Referring now to the drawings and the illustrative embodiments depicted therein, an interior rearview mirror and accessory or front camera module system 10 for a vehicle includes an interior rearview mirror assembly 11 having a mirror head 12 and a reflective element 14 positioned at a front portion of the mirror head 12 (FIG. 1). Mirror assembly 11 is adjustably mounted to an interior portion of a vehicle (such as to an interior surface of a vehicle windshield 16 or a headliner of a vehicle or the like) via a mounting structure or mounting configuration or assembly 18, which may be at or near an accessory module or windshield electronics module or front camera module 20 or the like. The reflective element 14 comprises an electro-optic reflective element, such as an electrochromic reflective element, and the dimming control circuitry 22 (FIG. 3) for controlling the dimming or darkening of the reflective element 14 is disposed or located remote from the mirror head 12, such as at or in the module 20 at or near the vehicle windshield 16. A glare sensor 19 may be disposed at the mirror head 12 and the glare sensor may be electrically wired or light piped to circuitry at the electronics module 20.

It is known to mount an interior rearview mirror assembly at a windshield of a vehicle, such as at a mounting button adhered at the interior surface of the vehicle windshield, and with a mirror head pivotally attached at the vehicle windshield, such as via a single pivot/ball or double pivot/ball mounting arrangement or mounting arm. Since the 1980s, electronics have increasingly been associated with interior rearview mirror assemblies, and in the 1990s, other accessories were disposed at the windshield (such as rain sensors, antennae, and/or the like, such as by utilizing aspects of the systems described in U.S. Pat. Nos. 6,690,268; 6,326,613 and/or 6,824,281, and/or U.S. Publication No. US-2006-0050018, published Mar. 9, 2006, which are hereby incorporated herein by reference in their entireties). Electrical accessories thus often cohabit with the mirror assembly at the mirror mounting button at or near the accessory module at the windshield.

While this works for the base or standard accessories, optional accessories, such as a forward facing camera or forward camera module (FCM) or the like, require different mirror assemblies or mirror heads to be manufactured and supplied as separate items. As more vehicles are moving towards use of standard FCMs, the circuitry required includes not only the imaging sensor, but various control circuitry and microprocessors and voltage stabilizing circuitry and circuit boards and the like. Often, a mirror head may now include a camera module, a display device, two photosensors (such as an ambient light photosensor and a glare light photosensor), at least one printed circuit board (PCB) and circuitry for controlling the dimming function of the electrochromic mirror reflective element of the mirror head.

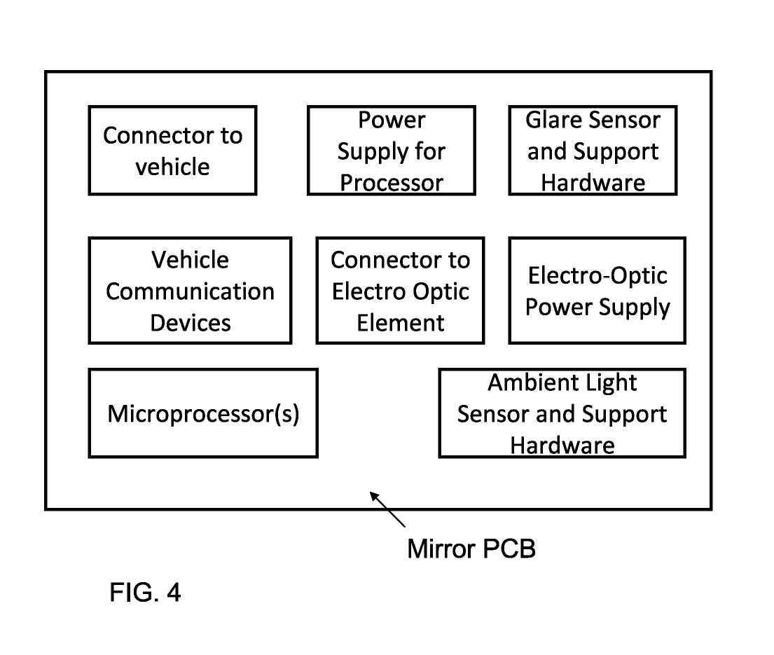

For example, and with reference to FIG. 4, a mirror circuit element or board or PCB may conventionally include or be associated with an electrical connector for electrically connecting to a wiring harness of the vehicle, a power supply for the processor, a glare sensor and support hardware and circuitry, an ambient light sensor and support hardware and circuitry, a vehicle communication device or devices, a connector to an electro-optic reflective element, an electro-optic power supply, and one or more microprocessors and/or the like. Depending on the application of a particular mirror head when implemented in accordance with the present invention, each of the elements shown in FIG. 4 may be greatly simplified or reduced or eliminated to reduce or substantially limit the electrical content in the mirror head, whereby the content may be part of the accessory module and the electro-optic reflective element of the mirror head may be connected to control circuitry of the accessory module, with no electro-optic control circuitry or power supply circuitry disposed in the mirror head.

Often, when a mirror head includes electrical content and an associated electronics module includes electronic content, there is a duplication of circuitry and features and functions between the mirror head and electronics module. For example, both the electronics module and the mirror head may include a bus controller and/or interface and/or node (such as for a CAN bus or LIN bus or the like of the vehicle), and the photosensor of the mirror head and a camera of a forward camera module may both be operable to determine the ambient lighting level at the vehicle. Thus, and in accordance with the present invention, such common or redundant elements or functions may be removed or delocated from the mirror head without having to significantly add to or modify the electronics module. The mirror head thus may have minimal electrical content, with the removed electrical content being synergistic with the electronics that are otherwise already present in the electronics module or forward camera module or the like. The common features or functions or circuit elements (such as, for example, communication nodes, ambient light sensing, processors, transceivers and/or the like) may be provided at already existing electronics modules or systems of the vehicle (such as an automatic headlamp control module or system of the vehicle and/or a camera module or system of the vehicle and/or the like), where the existing circuitry or system operates to provide the function that was previously provided by similar circuitry of the mirror head, without duplicate or redundant circuitry or components (and thus the need for an ambient photosensor or the like at the mirror head is obviated).

Optionally, and desirably, the mirror head may include user inputs or buttons or touch sensors or proximity sensors or the like, which may be in electrical or digital or wireless communication with circuitry at the electronics module, so that the mirror may include user inputs or buttons, but with no other electronics or circuitry or electrical content in the mirror head. For example, for a telematics mirror application, such as an ONSTAR® mirror or the like, the electrical content of the telematics system may be delocated from the mirror head and located at a remote accessory module or windshield electronics module, with the mirror head including the buttons for controlling the telematics system and with the buttons electrically connected to or in communication with the telematics circuitry at the module.

It is known to have an accessory module to which the likes of a mirror head pivotally attaches, such as via (a) a pivot ball element of the accessory module itself, wherein, for example, a socket element of the mirror head pivotally attaches to the pivot ball element, or (b) a mirror mounting button/attachment element of the accessory module, wherein, for example, a mirror mount (such as of the likes of a two ball interior rearview mirror assembly) attaches to the mirror mounting button. The present invention stands apart in that electronics (such as electrochromic mirror dimming or control circuitry and/or photosensors and/or the like) that conventionally are accommodated in the mirror head are, in accordance with the present invention, accommodated in the accessory module, where, advantageously and economically, the likes of microprocessors/DSPs, cameras, photosensors and other circuitry (present already in the accessory module) can form part of and/or share circuitry with the electrochromic mirror dimming or control circuitry. Thus, in accordance with the present invention, an automaker can elect to purchase the accessory module from a manufacturer and have it supplied in a form and function that allows that automaker to elect to purchase the mirror head from another manufacturer (for example, when the mirror head comprises a prismatic mirror element, it may be purchased from one manufacturer, and when the mirror head comprises an electrochromic mirror element, it may be purchased from another manufacturer). The mirror head provided by either of the mirror head manufacturers is configured to both mechanically and electrically/electronically couple to the accessory module provided by the first manufacturer, with the accessory module including the electrical elements or circuitry instead of the various mirror heads that may be selected for a particular vehicular application.

Thus, the present invention provides a separation of the electronics and accessories and circuitry from the mirror head. The mirror and accessory or front camera module system of the present invention provides a windshield electronics module or accessory module at the vehicle windshield that may be configured to have the mirror head pivotally attach thereto (such as via a single or double ball mounting arrangement, such as by utilizing aspects of the systems described in U.S. Pat. No. 6,824,281, which is hereby incorporated herein by reference in its entirety). The mirror head may be electrically connected to one or more electrical wires or leads from the module, and may make the electrical connection when the mechanical pivotal connection is made. The mirror head may include an electrochromic mirror reflective element and a glare sensor, with the EC dimming circuitry and other circuitry and accessories and the like being delocated from the head and located instead at the accessory module at the vehicle windshield. Thus, the mirror head has substantially reduced electronic content and thus provides a lower cost and lower weight mirror head, while also optionally providing a standard or uniform or common mirror head construction for all options across a vehicle line or product (in other words, any optional content, such as a camera or the like, may be located remotely from the common mirror head, such as at the accessory module or the like).

Optionally, the mirror head may include the likes of a display element or device (such as for displaying images, such as video images, through the mirror reflective element for viewing by the driver of the vehicle), with the control circuitry for the display device being disposed at or in the accessory module. The control signal and/or appropriate voltage feeds for controlling and/or powering the display device is communicated from the accessory module to the mirror head (such as via one or more electrically conductive elements or leads that pass along or through the pivot joint that pivotally attaches the mirror head at the vehicle windshield).

By providing the electrical control circuitry and other accessories at the windshield electronics module or accessory module, the accessory module can by provided or supplied by one manufacturer and the mirror head (with reduced electrical content, such as a glare sensor and an electrochromic reflective element and electrical leads for the glare sensor and reflective element) may be provided by the mirror manufacturer. The automotive manufacturer can thus purchase the accessory module (which may be configured with the electrical connections at a pivot element or ball of the module) from one manufacturer, and a common mirror head from a mirror manufacturer. At the vehicle assembly plant, an operator may readily snap the mirror head to the ball (or other mechanical connection) of the accessory module (and optionally, the module and the mirror head may be supplied together by the mirror manufacturer), whereby the mechanical connection and the electrical connection can be made between the accessory module and mirror head (such as by utilizing aspects of the systems described in U.S. Pat. No. 6,669,267, which is hereby incorporated herein by reference in its entirety).

The accessory module or front camera module or windshield electronics module thus may be provided with the desired electrical content, and may have a pivot mount or ball to which the mirror head may pivotally attach. The pivot mount may provide or include a groove or channel or passageway therethrough or therealong (such as a groove or key hole established at the surface of the ball) and the appropriate wiring (such as wires or a cable or bus cable to power the electrochromic reflective element and/or to receive signals from the glare sensor at the mirror head) may pass along the passageway and may be connected to a connector or lead or leads of the mirror head when the mirror head is snapped or otherwise attached at the pivot mount of the module at the vehicle windshield.

Thus, the vehicle manufacturer can purchase the electronics module or front camera module (which may have a foot or attachment element established thereat for mounting the mirror assembly thereto), which is configured to make all of the mechanical and electrical connections to the mirror head when the mirror head is snapped or otherwise attached thereto. The electronics module may have a wire connector that plugs into a connector at the mirror head or may have a wire or cable that passes through a passageway of the ball or attachment element, or may have a wire or cable that passes through a key hole or channel formed along an outer surface of a ball element, so as to provide electrical signals to the electrochromic mirror reflective element of the mirror head (so as to control the dimming of the reflective element via the dimming circuitry disposed at or in the electronics module). Thus, the vehicle manufacturer can purchase an electronics module with a common attachment element, whereby the mirror head snaps to the attachment element or ball, with the appropriate electrical connections being made to the mirror head when the mechanical connection is made.

In the illustrated embodiment, the reflective element 14 comprises an electro-optic reflective element, such as an electrochromic reflective element, and includes a front substrate having a front or first surface (the surface that generally faces the driver of a vehicle when the mirror assembly is normally mounted in the vehicle) and a rear or second surface opposite the front surface, and a rear substrate having a front or third surface and a rear or fourth surface opposite the front surface, with an electro-optic medium disposed between the second surface and the third surface and bounded by a perimeter seal of the reflective element (such as is known in the electrochromic mirror art). The second surface of front substrate has a transparent conductive coating established thereat, while the third surface of rear substrate has a metallic reflector coating established thereat. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element), while remaining within the spirit and scope of the present invention).

As shown in FIG. 3, electrical connections or wires 24a, 24b may be established at connection areas of the reflective element 14 to provide electrical connection to busbars or conductive traces at a respective one of the front and rear substrates to provide electrical current to the electrically conductive coatings at the rear surface of the front substrate and the front surface of the rear substrate for powering and dimming or varying the reflectance of the reflective element. The electrical wires or cables electrically connect the conductive coatings of the reflective element to auto-dimming circuitry 22 located remotely from the mirror head 12. As shown in FIG. 3, the auto-dimming or EC control circuitry 22 may be part of an electronic control unit (ECU) 26, which may provide electrical control for other systems of the vehicle or mirror and accessory module system. For example, the ECU 26 may provide power/control for a forward imaging system of the vehicle, an automatic headlamp control system of the vehicle, an automatic windshield wiper system of the vehicle, a surround view or “bird's eye” view system of the vehicle and/or the like.

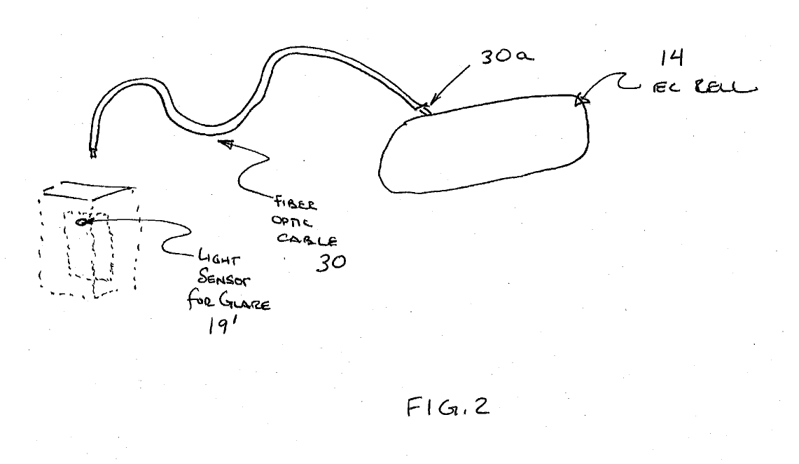

Optionally, and as shown in FIG. 3, a glare sensor 19 of the mirror head 12 may be wired via a wire or cable 28 to the EC dimming circuitry 22. The wire 28 may be routed with the wires 24a, 24b that power the electrochromic reflective element and may share one or more wires (such as a common ground wire) with the wires that power the electrochromic reflective element. Optionally, and such as shown in FIG. 2, a glare sensor 19′ may be disposed remotely from the mirror head 12, such as at the electronics module 20, and a fiber optic cable 30 may be disposed between the mirror head 12 and the electronics module 20. The fiber optic cable receives light at or near the reflective element 14 (such as via an end 30a of the fiber optic cable or light pipe 30 disposed at or within the bezel of the mirror head or behind the reflective element, such as at a window established through the mirror reflector or through the mirror reflector of a transflective reflective element) and sends the optical glare light to a light sensor or photosensor that is disposed within the remote electronics module. The light pipe or fiber optic cable 30 may be routed with the wires 24a, 24b that power the electrochromic reflective element.

Therefore, the present invention provides an interior rearview mirror and accessory or front camera module system that has a mirror head with reduced or minimal electrical content. The mirror head includes an auto-dimming electro-optic mirror reflective element yet does not include or contain the auto-dimming circuitry or control circuits. Optionally, the mirror head may include minor circuitry such as a glare sensor or glare sensing device, but that (along with the electro-optic reflective element and associated electrical connectors or terminals) may be the only electro-optic or electrochromic control-related circuitry in the mirror head. The auto-dimming circuitry and other circuitry and electrical content is imbedded into other systems, such as a forward imaging system, a headlamp control system, a surround view or bird's eye view camera and display system, and/or other electronic systems of the vehicle, which may be disposed at or in an electronics module (such as an accessory module or windshield electronics module or forward camera module or the like) disposed at the in-cabin surface of the vehicle windshield (or elsewhere within the vehicle). The reduced or minimal wiring or cable to electrically power the electro-optic reflective element may be routed to the mirror head and at or around or through the pivot joint or joints that pivotally mount the mirror head at the electronics module and/or the vehicle windshield.

Optionally, the electronics module may house an image sensor or camera, such as a forward viewing camera having a forward field of view through the windshield of the vehicle when the electronics module is mounted at the vehicle windshield. The control circuitry of the electronics module is at least in part is associated with the camera. The control circuitry may include an image processor that is operable to process image data captured by the camera. Optionally, the image processor may process captured image data for one or more driver assistance functions, such as, for example, two or more of (i) headlamp control, (ii) lane keeping, (iii) forward collision detection, (iv) collision mitigation braking, (v) automatic emergency braking, (vi) traffic sign recognition and (vii) pedestrian detection and the like. The control circuitry may receive inputs via a communication bus of the vehicle and/or may deliver output via a communication bus of the equipped vehicle.

The reflective element 14 and mirror head 12 are adjustable relative to the mounting arm or pivot assembly 18 (FIG. 1) to adjust the driver's rearward field of view when the mirror assembly is normally mounted at or in the vehicle. The mirror assembly includes a socket or pivot mount that may receive a ball member of a mounting arm of the pivot assembly or mounting structure 18, such as a double pivot or double ball mounting structure or a single pivot or single ball mounting structure or the like (such as a pivot mounting assembly of the types described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860; and/or 6,483,438, and/or U.S. patent application Ser. No. 11/226,628, filed Sep. 14, 2005 and published Mar. 23, 2006 as U.S. Pat. Pub. No. US-2006-0061008, and/or PCT Application No. PCT/US2010/028130, filed Mar. 22, 2010, which are hereby incorporated herein by reference in their entireties). The mounting assembly may have a ball or socket element mounted to or attached to or established at a mirror attachment plate or backing plate (which may optionally include or incorporate circuitry thereat or thereon) that is attached at the rear surface of the mirror reflective element (optionally with a mirror casing disposed over or receiving the attachment plate or with a cap portion of a mirror assembly attaching to the backing plate or the like, such as by utilizing aspects of the mirror assemblies described in U.S. Pat. No. 7,289,037, which is hereby incorporated herein by reference in its entirety), or the mounting assembly may have a ball or socket element mounted to or attached to or established at a portion of the mirror casing (or to an attachment element disposed at or in the mirror casing), where the ball or socket or pivot joint element pivotally attaches to a mounting arm or mounting structure that attaches to an interior portion of the vehicle, such as an inner surface of the vehicle windshield or a portion of the electronics module or the like.

In the illustrated embodiment, the electronics module or accessory module 20 is configured to be attached to an interior surface of a vehicle windshield (such as to a mounting button or attachment element adhered to the interior surface of the vehicle windshield). The accessory module may be mounted to a mounting button or attachment element at the vehicle windshield via a breakaway mounting construction, such as by utilizing aspects of the mounting constructions described in U.S. Pat. Nos. 5,820,097 and/or 5,100,095, which are hereby incorporated herein by reference in their entireties. The mounting arm may comprise a molded (such as injection molded) polymeric mounting arm or may be otherwise formed, depending on the particular application of the mirror assembly (and may utilize aspects of the mounting assemblies described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860; and/or 6,483,438, and/or U.S. patent application Ser. No. 11/226,628, filed Sep. 14, 2005 and published Mar. 23, 2006 as U.S. Pat. Pub. No. US-2006-0061008, and/or PCT Application No. PCT/US2010/028130, filed Mar. 22, 2010, which are hereby incorporated herein by reference in their entireties).

As discussed above, the mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic mirror assembly may utilize the principles disclosed in commonly assigned U.S. Pat. Nos. 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, and/or PCT Application No. PCT/US2010/029173, filed Mar. 30, 2010, which are hereby incorporated herein by reference in their entireties, and/or as disclosed in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Granquist, EDS., Optical Engineering Press, Wash. (1990), which are hereby incorporated by reference herein in their entireties; and/or as described in U.S. Pat. No. 7,195,381, which is hereby incorporated herein by reference in its entirety. The thicknesses and materials of the coatings on the substrates, such as on the third surface of the reflective element assembly, may be selected to provide a desired color or tint to the mirror reflective element, such as a blue colored reflector, such as is known in the art and such as described in U.S. Pat. Nos. 5,910,854; 6,420,036; and/or 7,274,501, which are all hereby incorporated herein by reference in their entireties.

Optionally, it is envisioned that aspects of the present invention may be suitable for an interior rearview mirror assembly that comprises a prismatic mirror assembly or a non-electro-optic mirror assembly (such as a generally planar or optionally slightly curved mirror substrate) or an electro-optic or electrochromic mirror assembly. For example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371; and 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177; and/or 7,255,451, which are all hereby incorporated herein by reference in their entireties, without affecting the scope of the present invention. A variety of mirror accessories and constructions are known in the art, such as those disclosed in U.S. Pat. Nos. 5,555,136; 5,582,383; 5,680,263; 5,984,482; 6,227,675; 6,229,319; and 6,315,421 (which are hereby incorporated herein by reference in their entireties), that can benefit from the present invention.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; and/or 7,255,451, and/or PCT Application No. PCT/US2010/032017, filed Apr. 22, 2010 and published Oct. 28, 2010 as International Publication No. WO 2010/124064, and/or PCT Application No. PCT/US10/51741, filed Oct. 7, 2010 and published Apr. 14, 2011 as International Publication No. WO 2011/044312, and/or U.S. patent application Ser. No. 11/226,628, filed Sep. 14, 2005 and published Mar. 23, 2006 as U.S. Pat. Pub. No. US-2006-0061008, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184,190 and/or 7,255,451, which are hereby incorporated herein by reference in their entireties). Optionally, other opaque or substantially opaque coatings or bands may be implemented while remaining within the spirit and scope of the present invention.

Optionally, any and/or all of the electrically powered accessories of the mirror assembly and/or accessory module may be powered via the power source of the vehicle and may be connected to a control and/or the power source when the mirror assembly and/or accessory module is installed in the vehicle (such as via electrical connection to a vehicle wiring harness or the like). Optionally, the mirror assembly may include a battery or independent power source for powering one or more of its electrical accessories. Optionally, the mirror assembly may include one or more ultrathin batteries. Such an ultrathin battery may be very thin and can be readily packaged within the mirror head (such as a rechargeable, about 0.3 mm thick, Organic Radical Battery (ORB), which is a flexible ultrathin battery that can be recharged quickly, and which is being developed by NEC Corp. of Tokyo, Japan). The battery may be readily packaged within the mirror head and can be recharged via the vehicle power source.

Other mirror designs or configurations may be contemplated for a mirror assembly of the mirror and accessory module system of the present invention. For example, the mirror assembly may include a plastic molding that comprises a portion that (a) abuts a circumferential edge of the mirror glass substrate (such as the front glass substrate of an electrochromic mirror reflective element or a glass prism of a prismatic mirror reflective element) and (b) has an outer curved surface that extends from generally adjacent to a first surface of the glass substrate and that may lack a sharp edge, such as described in U.S. Pat. Nos. 7,255,541; 7,289,037; 7,360,932; 8,049,640; and/or 8,277,059, and/or U.S. patent application Ser. No. 12/752,305, filed Apr. 1, 2010 (Attorney Docket DON01 P1606), which are hereby incorporated herein by reference in their entireties. Optionally, for example, the mirror assembly may include a reflective element with a beveled or rounded or curved front perimeter of the glass substrate that may be exposed to, contactable by and viewable by the driver of the vehicle when the interior rearview mirror assembly is normally mounted in the vehicle, such as described in U.S. Des. Pat. Nos. D661,234; D660,208; D633,423; D633,019; D638,761; and/or D647,017, and/or PCT Application No. PCT/US2011/056295, filed Oct. 14, 2011, and/or PCT Application No. PCT/US2010/032017, filed Apr. 22, 2010 and published Oct. 28, 2010 as International Publication No. WO 2010/124064, and/or PCT Application No. PCT/US10/51741, filed Oct. 7, 2010 and published Apr. 14, 2011 as International Publication No. WO 2011/044312, and/or PCT Application No. PCT/US2012/064398, filed Nov. 9, 2012 (Attorney Docket DON01 FP-1958(PCT)), and/or PCT Application No. PCT/US2013/027346, filed Feb. 22, 2013 (Attorney Docket DON09 FP-2041(PCT)), which are all hereby incorporated herein by reference in their entireties (and with electrochromic and prismatic mirrors of such construction commercially available from the assignee of this application under the trade name INFINITY™ mirror). Optionally, the mirror assembly may include a conventional bezel, such as described in U.S. Pat. No. 7,224,324, which is hereby incorporated herein by reference in its entirety.

The mirror casing of mirror head 12 may comprise any suitable mirror casing, and may comprise a plastic or polymeric molded casing or housing. Optionally, for applications where the perimeter edge region of the front substrate of the mirror reflective element 14 is curved and exposed (such as discussed above), the mirror casing may comprise a metallic finish or high gloss finish or textured finish or the like at least at the forward portion that abuts the rear of the front substrate (or the rear of a prismatic substrate for prismatic mirror applications).

Optionally, the interior rearview mirror assembly may comprise or utilize aspects of other types of casings or the like, such as described in U.S. Pat. Nos. 7,338,177; 7,289,037; 7,249,860; 6,439,755; 4,826,289; and 6,501,387, which are all hereby incorporated herein by reference in their entireties, without affecting the scope of the present invention. For example, the mirror assembly may utilize aspects of the flush or frameless or bezelless reflective elements described in U.S. Pat. Nos. 7,626,749; 7,360,932; 7,289,037; 7,255,451; 7,274,501; and/or 7,184,190, and/or in U.S. patent application Ser. No. 11/226,628, filed Sep. 14, 2005 and published Mar. 23, 2006 as U.S. Pat. Pub. No. US-2006-0061008; and/or Ser. No. 10/538,724, filed Jun. 13, 2005 and published Mar. 9, 2006 as U.S. Pat. Pub. No. US-2006-0050018, which are all hereby incorporated herein by reference in their entireties.

Optionally, the mirror casing and/or reflective element may include customized or personalized viewable characteristics, such as color or symbols or indicia selected by the vehicle manufacturer or owner of the vehicle, such as the customization characteristics described in U.S. Pat. Nos. 7,626,749; 7,255,451; 7,289,037, which are hereby incorporated herein by reference in their entireties.

Optionally, the mirror and accessory module system and mirror assembly and accessory module of the present invention may utilize aspects of the mirror assemblies described in U.S. Pat. Nos. 5,066,112; 7,626,749; 7,360,932; 7,274,501; 7,184,190; and/or 7,255,451, and/or PCT Application No. PCT/US2010/032017, filed Apr. 22, 2010 and published Oct. 28, 2010 as International Publication No. WO 2010/124064, and/or PCT Application No. PCT/US10/51741, filed Oct. 7, 2010 and published Apr. 14, 2011 as International Publication No. WO 2011/044312, and/or U.S. patent application Ser. No. 11/226,628, filed Sep. 14, 2005 and published Mar. 23, 2006 as U.S. Pat. Pub. No. US-2006-0061008, which are all hereby incorporated herein by reference in their entireties).

Optionally, the mirror and accessory module system may include one or more displays (such as at the accessory module or the like), such as the types disclosed in U.S. Pat. Nos. 5,530,240 and/or 6,329,925, which are hereby incorporated herein by reference in their entireties, and/or display-on-demand transflective type displays, such as the types disclosed in U.S. Pat. Nos. 7,855,755; 7,274,501; 7,255,451; 7,195,381; 7,184,190; 7,046,448; 5,668,663; 5,724,187 and/or 6,690,268, and/or in U.S. patent application Ser. No. 11/226,628, filed Sep. 14, 2005 and published Mar. 23, 2006 as U.S. Pat. Pub. No. US-2006-0061008; and/or Ser. No. 10/538,724, filed Jun. 13, 2005 and published Mar. 9, 2006 as U.S. Pat. Pub. No. US-2006-0050018, which are all hereby incorporated herein by reference in their entireties.

A video display screen device or module of the mirror and accessory module system of the present invention may comprise any suitable type of video screen and is operable to display images in response to an input or signal from a control or imaging system. For example, the video display screen may comprise a multi-pixel liquid crystal module (LCM) or liquid crystal video display (LCD), preferably a thin film transistor (TFT) multi-pixel liquid crystal video display (such as discussed below), or the video screen may comprise a multi-pixel organic electroluminescent video display or a multi-pixel light emitting diode (LED) video display, such as an organic light emitting diode (OLED) or inorganic light emitting video diode display or the like, or an electroluminescent (EL) video display or the like. For example, the video display screen may comprise a video screen of the types disclosed in U.S. Pat. Nos. 7,855,755; 7,734,392; 7,370,983; 7,338,177; 7,274,501; 7,255,451; 7,195,381; 7,184,190; 6,902,284; 6,690,268; 6,428,172; 6,420,975; 5,668,663; 5,724,187; 5,416,313; 5,285,060; 5,193,029 and/or 4,793,690, and/or U.S. patent application Ser. No. 13/023,750, filed Feb. 9, 2011 (Attorney Docket DON01 P-1679); Ser. No. 10/538,724, filed Jun. 13, 2005 and published Mar. 9, 2006 as U.S. Pat. Pub. No. US-2006-0050018; Ser. No. 11/226,628, filed Sep. 14, 2005 and published Mar. 23, 2006 as U.S. Pat. Pub. No. US-2006-0061008; Ser. No. 12/091,525, filed Apr. 25, 2008 and published Jan. 15, 2009 as U.S. Pat. Pub. No. US-2009-0015736; Ser. No. 12/091,525, filed Apr. 25, 2008 and published Jan. 15, 2009 as U.S. Pat. Pub. No. US-2009-0015736; Ser. No. 12/578,732, filed Oct. 14, 2009 and published Apr. 22, 2010 as U.S. Pat. Pub. No. US-2010-0097469; Ser. No. 09/585,379, filed Jun. 1, 2000, now abandoned; and/or Ser. No. 10/207,291, filed Jul. 29, 2002, now abandoned, and/or PCT Application No. PCT/US10/47256, filed Aug. 31, 2010, which are all hereby incorporated herein by reference in their entireties.

Optionally, the displays may be of types disclosed in U.S. Pat. Nos. 5,530,240 and/or 6,329,925, which are hereby incorporated herein by reference in their entireties, and/or may be display-on-demand or transflective type displays, such as the types disclosed in U.S. Pat. Nos. 7,338,177; 7,274,501; 7,195,381; 6,690,298; 5,668,663 and/or 5,724,187, and/or in U.S. patent application Ser. No. 11/226,628, filed Sep. 14, 2005 and published Mar. 23, 2006 as U.S. Pat. Pub. No. US-2006-0061008; and/or Ser. No. 12/091,525, filed Jul. 15, 2008 and published Jan. 15, 2009 as U.S. Pat. Pub. No. US-2009-0015736, which are all hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, such as the types disclosed in U.S. Pat. Nos. 5,550,677; 5,760,962; 6,396,397; 6,097,023; 5,877,897; and 5,796,094, and/or U.S. patent application Ser. No. 10/534,632, filed May 11, 2005 and published Aug. 3, 2006 as U.S. Pat. Pub. No. US-2006-0171704, which are hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle.

Optionally, a rear camera, such as a rear backup video camera/imager or the like (such as a camera and system of the types described in U.S. Pat. Nos. 5,550,677; 5,670,935; 6,498,620; 6,222,447; and/or 5,949,331, which are hereby incorporated herein by reference in their entireties), may be disposed at the vehicle and may have a rearward field of view rearward of the vehicle for capturing images rearward of the vehicle such as for driver assistance during a reversing maneuver of the vehicle or the like. Because such a rear camera has a rearward field of view, the rearward facing camera may be operable to capture images of rearwardly approaching or following vehicles that are behind the vehicle equipped with the rearward facing camera when the vehicle so equipped is driving forwardly along the road or highway. It is envisioned that an image processor or controller (such as an EyeQ™ image processing chip available from Mobileye Vision Technologies Ltd. of Jerusalem, Israel, and such as an image processor of the types described in PCT Application No. PCT/US10/25545, filed Feb. 25, 2010 and published Sep. 2, 2010 as International Pub. No. WO/2010/099416, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing. Using principles of the systems described in U.S. Pat. No. 5,550,677, which is hereby incorporated herein by reference in its entirety, the system may operate to independently control any one or more of the interior rearview mirror assembly and the exterior rearview mirror assemblies of the equipped vehicle, such as based on the intensity and location of glare light detected by the camera and image processor. Such a rear reversing or backup camera and controller can also operate to detect the ambient light level present at the vehicle and may adjust the dimming of the mirror reflective element accordingly, and/or may adjust other displays, lighting and/or accessories of the vehicle in accordance with and responsive to the ambient light detection by the rear backup camera (or by other cameras on the vehicle that view exterior to the vehicle). Such glare detection and ambient light detection and image processing of image data captured by a rear backup assist camera of the vehicle may obviate the need for a separate glare sensor elsewhere at the vehicle, such as at or in the interior rearview mirror assembly of the vehicle or the like. Such image processing and such a mirror control system may utilize aspects of the imaging systems described in U.S. Pat. Nos. 5,550,677; 5,670,935; 5,760,962; 6,201,642; 6,396,397; 6,498,620; 6,097,023; 5,877,897; and 5,796,094, which are hereby incorporated herein by reference in their entireties.

Optionally, the system may be part of or associated with a vehicle vision system and the vision system may comprise or utilize a plurality of cameras, and the vision system (utilizing a rearward facing camera and sidewardly facing cameras and a forwardly facing cameras disposed at the vehicle) may provide a display of a top-down view or bird's eye view of the vehicle or a surround view at the vehicle, such as by utilizing aspects of the vision systems described in International Publication Nos. WO 2010/099416; WO 2011/028686, and/or WO 2012/0757250, and/or PCT Application No. PCT/US2012/068331, filed Dec. 7, 2012 (Attorney Docket MAGO4 FP-1967(PCT)), and/or PCT Application No. PCT/US2013/022119, filed Jan. 18, 2013 (Attorney Docket MAGO4 FP-1997(PCT)), and/or PCT Application No. PCT/US2012/064980, filed Nov. 14, 2012 (Attorney Docket MAGO4 FP-1959(PCT)), and/or PCT Application No. PCT/CA2012/000378, filed Apr. 25, 2012, and/or U.S. patent application Ser. No. 13/333,337, filed Dec. 21, 2011 (Attorney Docket DON01 P-1797), which are hereby incorporated herein by reference in their entireties.

Optionally, the mirror and accessory module system (such as at the electronics module) may include other electrically operated or powered accessories, such as a compass sensor and compass display. Such a compass sensor and circuitry for the compass system that detects and displays the vehicle directional heading to a driver of the vehicle may comprise any suitable compass sensor and/or circuitry, such as a compass system and compass circuitry that utilizes aspects of the compass systems described in U.S. Pat. Nos. 7,370,983; 7,329,013; 7,289,037; 7,249,860; 7,004,593; 6,928,366; 6,642,851; 6,140,933; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; and/or 6,513,252, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Pat. Pub. No. US-2006-0061008, which are all hereby incorporated herein by reference in their entireties. The compass circuitry may include compass sensors, such as a magneto-responsive sensor, such as a magneto-resistive sensor, a magneto-capacitive sensor, a Hall sensor, a magneto-inductive sensor, a flux-gate sensor or the like. The compass sensor may be incorporated in or associated with a compass system and/or display system for displaying a directional heading of the vehicle to the driver, such as a compass system of the types described in U.S. Pat. Nos. 7,289,037; 5,924,212; 4,862,594; 4,937,945; 5,131,154; 5,255,442; 5,632,092; and/or 7,004,593, which are all hereby incorporated herein by reference in their entireties. Optionally, an integrated automotive “compass-on-a-chip” may be disposed in a cavity of the mounting base or electronics module of the mirror and may comprise at least two sensor elements (such as magneto-responsive sensor elements, or a Hall effect sensor or multiple Hall effect sensors), associated A/D and D/A converters, associated microprocessor(s) and memory, associated signal processing and filtering, associated display driver and associated LIN/CAN BUS interface and the like, all (or a sub-set thereof) created or disposed or commonly established onto a semiconductor chip surface/substrate or silicon substrate, such as utilizing CMOS technology and/or fabrication techniques as known in the semiconductor manufacturing arts, and constituting an application specific integrated chip (“ASIC”), such as utilizing principles described in U.S. Pat. Nos. 7,815,326; 7,004,593; 7,329,013 and/or 7,370,983, and/or U.S. patent application Ser. No. 11/226,628, filed Sep. 14, 2005 and published Mar. 23, 2006 as U.S. Pat. Pub. No. US-2006-0061008, which are hereby incorporated herein by reference in their entireties, and/or such as by utilizing aspects of an EC driver-on-a-chip such as described in U.S. Pat. No. 7,480,149, which is hereby incorporated herein by reference in its entirety.

Within the scope of the present invention, various touch or proximity technologies, including surface capacitance touch, projection (projected) capacitance touch, resistive touch, infrared (IR) touch (where an IR beam or the like is interrupted and/or sensed), surface acoustic wave (SAW) touch, and close field effect touch, as are commonly known in the touch sensor art, may be implemented, such as at the mirror head or the accessory module. Such touch sensors may utilize aspects of the user input systems described in PCT Application No. PCT/US2011/056295, filed Oct. 14, 2011, and/or PCT Application No. PCT/US10/51741, filed Oct. 7, 2010 and published Apr. 14, 2011 as International Publication No. WO 2011/044312, U.S. Pat. Nos. 8,154,418 and/or 7,360,932 and/or U.S. patent application Ser. No. 12/091,525, filed Apr. 25, 2008 and published Jan. 15, 2009 as U.S. Pat. Pub. No. US-2009-0015736; Ser. No. 11/239,980, filed Sep. 30, 2005 and published Jun. 15, 2006 as U.S. Pat. Pub. No. US-2006-0125919; and/or Ser. No. 12/576,550, filed Oct. 9, 2009 and published Apr. 15, 2010 as U.S. Pat. Pub. No. US-2010-0091394, which are hereby incorporated herein by reference in their entireties. The touch or proximity sensors may utilize aspects of the systems or devices described in U.S. Pat. Nos. 5,594,222; 6,001,486; 6,310,611; 6,320,282; 6,627,918; 7,224,324; 7,253,723; 7,249,860; 7,446,924; 7,360,932; 7,255,541; 6,504,531; 6,501,465; 6,492,980; 6,452,479; 6,437,258; and/or 6,369,804, and/or PCT Application No. PCT/US03/40611, filed Dec. 19, 2003 and published on Jul. 15, 2004 as PCT Publication No. WO 2004/058540 A2, which are hereby incorporated herein by reference in their entireties.

Optionally, for example, a touch sensitive element for the mirror and accessory module system of the present invention can be a capacitive type or a resistive type or an inductive type, such as are known in the touch panel arts, including such as disclosed in U.S. Pat. Nos. 3,798,370; 4,198,539; 4,661,655; 4,731,508; 4,822,957; 5,045,644; 6,001,486; 6,087,012; 6,627,918; 6,787,240; and/or 7,224,324, and U.S. patent application Ser. No. 09/946,228, filed Sep. 5, 2001 and published Mar. 14, 2002 as U.S. Pat. Publication No. US2002/0031622; and/or Ser. No. 10/744,522, filed Dec. 23, 2003 and published Jul. 15, 2004 as U.S. Pat. Publication No. US2004/0137240, and/or U.S. provisional application Ser. No. 60/244,577, filed Oct. 31, 2000, which are hereby incorporated herein by reference in their entireties. Also, the touch inputs of the present invention do not necessarily require physical contact between the driver's finger and touch sensitive element. Close approach of the driver's finger (or a stylus or other touch/proximity means) to the touch sensitive surface may suffice to achieve a touch input. This can thus be by non-contacting input or by contacting input by a variety of means such as thermal or pyro detection, capacitive or inductive detection, resistive sensing, electromagnetic disturbance sensing or the like. Optionally, a reading of the fingerprint of the person touching the mirror reflector can be taken to verify identity of the person and so authorize particular actions in response (such as turning on the vehicle ignition, such as to start the engine, conducting a remote banking transaction, identifying a person for the purpose of setting vehicle accessories such as seat position, mirror position, climate control, audio system controls, ride system, and the like to the particular setting preferred by that individual person such as is common in vehicle memory systems).

Optionally, the user inputs or buttons may comprise user inputs for a garage door opening system, such as a vehicle based garage door opening system of the types described in U.S. Pat. Nos. 6,396,408; 6,362,771; 7,023,322; and/or 5,798,688, which are hereby incorporated herein by reference in their entireties. The user inputs may also or otherwise function to activate and deactivate a display or function or accessory, and/or may activate/deactivate and/or commence a calibration of a compass system of the mirror assembly and/or vehicle. The compass system may include compass sensors and circuitry within the mirror assembly or within a compass pod or module at or near or associated with the mirror assembly. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; and 6,420,975; 6,477,464; 6,946,978; 7,308,341; 7,167,796; 7,004,593; 7,657,052; and/or 6,678,614, and/or U.S. patent application Ser. No. 10/538,724, filed Jun. 13, 2005 and published Mar. 9, 2006 as U.S. Pat. Pub. No. US-2006-0050018, which are all hereby incorporated herein by reference in their entireties.

Optionally, the mirror and accessory module system may include one or more other accessories at or within the accessory module, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 7,720,580; 7,038,577; 6,882,287; 5,929,786 and/or 5,786,772, transmitters and/or receivers, such as a garage door opener or a vehicle door unlocking system or the like (such as a remote keyless entry system or the like, a digital network, such as described in U.S. Pat. No. 5,798,575, a high/low headlamp controller, such as disclosed in U.S. Pat. Nos. 5,796,094 and/or 5,715,093, a memory mirror system, such as disclosed in U.S. Pat. No. 5,796,176, a hands-free phone attachment, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775; and/or 7,249,860, microphones, such as disclosed in U.S. Pat. Nos. 7,657,052; 6,243,003; 6,278,377; and/or 6,420,975, speakers, a voice recorder, transmitters and/or receivers, such as for a garage door opener, an imaging system or components or circuitry or display thereof, such as an imaging and/or display system of the types described in U.S. Pat. Nos. 7,400,435; 7,526,103; 6,690,268 and/or 6,847,487, and/or U.S. patent application Ser. No. 11/239,980, filed Sep. 30, 2005 and published Jun. 15, 2006 as U.S. Pat. Pub. No. US-2006-0125919, a seat occupancy detector, a remote starter control, a yaw sensor, a clock, a carbon monoxide detector, status displays, such as displays that display a status of a door of the vehicle, a transmission selection (4wd/2wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205; and/or 7,423,522, and/or an ONSTAR® system, a compass, such as disclosed in U.S. Pat. Nos. 5,924,212; 4,862,594; 4,937,945; 5,131,154; 5,255,442; and/or 5,632,092, and/or any other accessory or circuitry or the like (with all of the above-referenced patents and PCT and U.S. patent applications being commonly assigned to Donnelly Corporation and being hereby incorporated herein by reference in their entireties).

Optionally, the accessory module or forward camera module may include an imaging sensor (such as a forward facing imaging sensor or camera that has a forward field of view through the vehicle windshield) that may be part of or may provide an image output for a vehicle vision system, such as a headlamp control system or lane departure warning system or object detection system or other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,038,577; 7,004,606; and/or 7,720,580, and/or U.S. patent application Ser. No. 10/534,632, filed May 11, 2005 and published Aug. 3, 2006 as U.S. Patent Publication No. US-2006-0171704; Ser. No. 12/091,359, filed Jun. 10, 2008 and published Oct. 1, 2009 as U.S. Pat. Pub. No. US-2009-0244361; and/or Ser. No. 12/377,054, filed Feb. 10, 2009 and published Aug. 26, 2010 as U.S. Pat. Pub. No. US-2010-0214791, and/or PCT Application No. PCT/US08/78700, filed Oct. 3, 2008 and published Apr. 9, 2009 as International Publication No. WO 2009/046268, and/or PCT Application No. PCT/US08/76022, filed Sep. 11, 2008 and published Mar. 19, 2009 as International Publication No. WO 2009/036176, which are all hereby incorporated herein by reference in their entireties. The sensor may include a lens element or optic between the imaging plane of the imaging sensor and the forward scene to substantially focus the scene at an image plane of the imaging sensor. The imaging sensor may comprise an image sensing module or the like, and may utilize aspects described in U.S. patent application Ser. No. 10/534,632, filed May 11, 2005 and published Aug. 3, 2006 as U.S. Pat. Pub. No. US-2006-0171704; and/or Ser. No. 12/091,359, filed Oct. 27, 2006 and published Oct. 1, 2009 as U.S. Pat. Pub. No. US-2009-0244361, which are hereby incorporated herein by reference in their entireties.

The connection or link between the controls or control circuitry and the mirror reflective element and/or any circuitry disposed at or in the mirror head and/or other systems and accessories of the mirror and accessory module system may be provided via vehicle electronic or communication systems and the like, and may be connected via various protocols or nodes, such as BLUETOOTH®, SCP, UBP, J1850, CAN J2284, Fire Wire 1394, MOST, LIN, FlexRay™, Byte Flight and/or the like, or other vehicle-based or in-vehicle communication links or systems (such as WIFI and/or IRDA) and/or the like, or via VHF or UHF or other wireless transmission formats, depending on the particular application of the mirror/accessory system and the vehicle. Optionally, the connections or links may be provided via various wireless connectivity or links, without affecting the scope of the present invention.

Changes and modifications in the specifically described embodiments may be carried out without departing from the principles of the present invention, which is intended to be limited only by the scope of the appended claims as interpreted according to the principles of patent law.

1. An accessory system for a vehicle, said accessory system comprising:
an electronics module disposed at an interior surface of a windshield of a vehicle equipped with said accessory system;
a mirror head having an electro-optic reflective element, wherein said mirror head is pivotally attached at said electronics module;
control circuitry disposed in said electronics module;
wherein, when said mirror head is pivotally attached at said electronics module, said control circuitry is electrically connected to said electro-optic reflective element of said mirror head; and
wherein said control circuitry is at least operable to control the dimming of said electro-optic reflective element responsive to at least one photosensor, and wherein said control circuitry is associated with at least one other function or system of the equipped vehicle.

2. The accessory system of claim 1, wherein said at least one photosensor comprises an ambient light sensor and a glare light sensor.

3. The accessory system of claim 2, wherein said ambient light sensor is disposed at said electronics module.

4. The accessory system of claim 3, wherein said glare light sensor is disposed at said mirror head and is electrically connected to said control circuitry when said mirror head is pivotally attached at said electronics module.

5. The accessory system of claim 3, wherein said glare light sensor is disposed at said electronics module, and wherein a light pipe has a light receiving end disposed at said mirror head and is routed between said mirror head and said control circuitry when said mirror head is pivotally attached at said electronics module.

6. The accessory system of claim 1, wherein said electronics module houses a camera and wherein said control circuitry is at least in part associated with said camera.

7. The accessory system of claim 6, wherein said control circuitry comprises an image processor operable to process image data captured by said camera, and wherein said camera has a forward field of view through the windshield of the equipped vehicle.

8. The accessory system of claim 7, wherein said image processor processes captured image data for at least two driver assistance functions selected from the group consisting of (i) headlamp control, (ii) lane keeping, (iii) forward collision detection, (iv) collision mitigation braking, (v) automatic emergency braking, (vi) traffic sign recognition and (vii) pedestrian detection.

9. The accessory system of claim 8, wherein said control circuitry receives input via and delivers output via a communication bus of the equipped vehicle.

10. The accessory system of claim 9, wherein said camera comprises a CMOS photosensor array, and wherein said image processor comprises an EyeQ™ processor.

11. The accessory system of claim 1, wherein said electronics module detachably attaches to an attachment element that is adhesively attached at the interior surface of the windshield of the equipped vehicle.

12. An accessory system for a vehicle, said accessory system comprising:
an electronics module disposed at an interior surface of a windshield of a vehicle equipped with said accessory system;
wherein said electronics module detachably attaches to an attachment element that is adhesively attached at the interior surface of the windshield of the equipped vehicle;
a mirror head having an electro-optic reflective element, wherein said mirror head is pivotally attached at said electronics module;
control circuitry disposed in said electronics module;
wherein said electronics module houses a camera having a forward field of view through the windshield of the equipped vehicle;
wherein said control circuitry receives input via and delivers output via a communication bus of the equipped vehicle;
wherein said control circuitry comprises an image processor operable to process image data captured by said camera;
wherein, when said mirror head is pivotally attached at said electronics module, said control circuitry is electrically connected to said electro-optic reflective element of said mirror head;
wherein said control circuitry is at least operable to control the dimming of said electro-optic reflective element responsive to at least one photosensor; and
wherein said image processor processes captured image data for at least two driver assistance functions selected from the group consisting of (i) headlamp control, (ii) lane keeping, (iii) forward collision detection, (iv) collision mitigation braking, (v) automatic emergency braking, (vi) traffic sign recognition and (vii) pedestrian detection.

13. The accessory system of claim 12, wherein said camera comprises a CMOS photosensor array, and wherein said image processor comprises an EyeQ™ processor.

14. The accessory system of claim 12, wherein said at least one photosensor comprises an ambient light sensor and a glare light sensor.

15. The accessory system of claim 14, wherein said ambient light sensor is disposed at said electronics module and wherein one of (i) said glare light sensor is disposed at said mirror head and is electrically connected to said control circuitry when said mirror head is pivotally attached at said electronics module and (ii) said glare light sensor is disposed at said electronics module and wherein a light pipe has a light receiving end disposed at said mirror head and is routed between said mirror head and said control circuitry when said mirror head is pivotally attached at said electronics module.

16. The accessory system of claim 12, wherein said at least one photosensor comprises an ambient light photosensor disposed at said electronics module.

17. An accessory system for a vehicle, said accessory system comprising:
an electronics module disposed at an interior surface of a windshield of a vehicle equipped with said accessory system;
wherein said electronics module detachably attaches to an attachment element that is adhesively attached at the interior surface of the windshield of the equipped vehicle;
a mirror head having an electrochromic reflective element, wherein said mirror head is pivotally attached at said electronics module;
control circuitry disposed in said electronics module;
wherein said electronics module houses a camera having a forward field of view through the windshield of the equipped vehicle;
wherein said camera comprises a CMOS photosensor array;
wherein said control circuitry receives input via and delivers output via a communication bus of the equipped vehicle;
wherein said control circuitry comprises an image processor operable to process image data captured by said camera;
wherein, when said mirror head is pivotally attached at said electronics module, said control circuitry is electrically connected to said electrochromic reflective element of said mirror head;
wherein said control circuitry is at least operable to control the dimming of said electrochromic reflective element responsive to at least one photosensor;
wherein at least one of (a) said at least one photosensor comprises an ambient light sensor disposed at said electronics module and (b) said at least one photosensor comprises a glare light sensor; and
wherein said image processor processes captured image data for at least two driver assistance functions selected from the group consisting of (i) headlamp control, (ii) lane keeping, (iii) forward collision detection, (iv) collision mitigation braking, (v) automatic emergency braking, (vi) traffic sign recognition and (vii) pedestrian detection.

18. The accessory system of claim 17, wherein said image processor comprises an EyeQ™ processor.

19. The accessory system of claim 17, wherein said at least one photosensor comprises a glare light sensor.

20. The accessory system of claim 19, wherein said glare light sensor is one of (i) disposed at said mirror head and is electrically connected to said control circuitry when said mirror head is pivotally attached at said electronics module and (ii) disposed at said electronics module and wherein a light pipe has a light receiving end disposed at said mirror head and is routed between said mirror head and said control circuitry when said mirror head is pivotally attached at said electronics module.
